(19) United States
(12) Patent Application Publication
(10) Pub. No.: US 2009/0265201 A1
(43) Pub. Date: Oct. 22, 2009

(54) METHOD AND APPARATUS FOR DETERMINING SECURITY SOLUTION

(75) Inventors: Min Sik KIM, Daejeon (KR); Jung Gil PARK, Daejeon (KR); Soon Jwa HONG, Daejeon (KR); Peter Hoh In, Seoul (KR); Taek LEE, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/426,678

(22) Filed: Apr. 20, 2009

(30) Foreign Application Priority Data
Apr. 21, 2008 (KR) 10-2008-0036667
Aug. 19, 2008 (KR) 10-2008-0080664

(51) Int. Cl. G06Q 10/00

(52) U.S. Cl. 705/7

(57) ABSTRACT

Provided are a method and apparatus for determining a security solution. The method and apparatus generate a security solution analysis model for analyzing effects on investment of security solution combinations consisting of several security solution candidates on the basis of integer programming (IP), standardize various constraints that have significant effects on security solution determination on the basis of IP, and apply the standardized constraints to the security solution analysis model, thereby determining a security solution combination having the smallest residual risk while satisfying the constraints as an optimum security solution combination.

According to the method and apparatus, an optimum security solution combination that can minimize a residual risk while satisfying various constraints is rapidly and accurately determined. Thus, it is possible to support effective determination in information security investment.

### CROSS-REFERENCE TO RELATED APPLICATION

This application claims priority to and the benefit of Korean Patent Application Nos. 10-2008-0036667, filed Apr. 21, 2008, and 10-2008-0080664, filed Aug. 19, 2008, the disclosure of which is incorporated herein by reference in its entirety.

### BACKGROUND

1. Field of the Invention

The present invention relates to a method and apparatus for determining a security solution, and more particularly, to a method and apparatus capable of rapidly and accurately determining an optimum security solution among several on the basis of integer programming (IP).

2. Discussion of Related Art

In the past, companies have invested in constructing new information technology (IT) infrastructure or business solutions to reduce costs, improve productivity and solve detailed business problems. However, it has been reported in recent years that the effect and increase of returns based on IT investment are not as large as expected. Thus, IT evaluation, which can guarantee the validity and veracity that IT actually assists the development of a company and results in a substantial outcome, has come into the limelight.

Therefore, a method of detecting how much work output is obtained from the total cost used for IT construction and management, developing a return on investment (ROI) model on IT, and then analyzing the economic value of IT using the ROI model, is widely used.

Unlike IT investment, the purpose of investment in information security is not to obtain benefit, but to protect information property and minimize the probability of potential loss.

In other words, in evaluating a security solution for information security, it is important to reduce the potential risk (potential risk=expected potential loss×probability of accident) of information property that may be exposed to security threats. To this end, a risk-based ROI (RROI) model shown in Equation 1 below is used.

$$R R O I = \frac{BaselineRisk - ResidualRisk - Cost}{Cost} \times 100 \qquad [ Equation 1 ]$$

In Equation 1 above, Baseline Risk denotes a basis risk, Residual Risk denotes a remaining risk, and Cost denotes an investment.

For example, assume that a cost of ten thousand dollars is required to implement security solution A, and a cost of thirty thousand dollars is required to implement security solution B. Also, assume that the potential baseline risk of a company is seventy five thousand dollars (potential risk=expected potential loss of one hundred thousand dollars×accident probability of 75%). Here, let us also assume that the residual risk is reduced to fifty thousand dollars when security solution A is employed, and is reduced to twenty five thousand dollars when security solution B is employed.

In consideration of the residual risk alone, investment must be made in security solution B. However, in consideration of an ROI constraint, it is better to invest in security solution A (RROI_{A}=150%>RROI_{B}=66.7%).

Some available security solutions to be implemented may be very difficult to determine due to a variety of complex constraints, e.g., cost, ROI, acceptable risk level, and dependency between the security solutions. Thus, a considerable amount of time and cost are required to determine a security solution.

Consequently, a means for rapidly and accurately determining an optimum security solution among several in consideration of various constraints as well as ROI, is necessary.

### SUMMARY OF THE INVENTION

The present invention is directed to rapidly and accurately determining an optimum security solution among several using integer programming (IP), which is a mathematical standardization technique.

One aspect of the present invention provides a method of determining a security solution, comprising: composing security solution combinations by determining security solution candidates from among available security solutions; generating a security solution analysis model for analyzing effects on investment of the security solution combinations on the basis of integer programming (IP); standardizing a constraint on the basis of IP; calculating a total residual risk of the security solution combinations by applying the standardized constraint to the security solution analysis model; and determining a security solution combination having the smallest residual risk as an optimum security solution combination.

Another aspect of the present invention provides an apparatus for determining a security solution, comprising: a security solution candidate determiner for composing security solution combinations by determining security solution candidates from among available security solutions; a security solution analysis model for analyzing effects on investment of the security solution combinations on the basis of IP; a constraint standardizer for standardizing a constraint on the basis of IP; a residual risk calculator for calculating a total residual risk of the security solution combinations by applying the constraint standardized by the constraint standardizer to the security solution analysis model; and a security solution determiner for determining a security solution combination having the smallest residual risk as an optimum security solution combination.

The security solution analysis model f may be defined as

$$f ( {s}_{1} , {s}_{2} , … , {s}_{N} ) = {\sum }_{j = 1}^{M} ( {d}_{j} \cdot {\prod }_{i = I}^{N} ( ( {r}_{ij} - 1 ) \cdot {s}_{i} + 1 ) ) .$$

Here, M denotes the number of threats, N denotes the number of security solution candidates, sᵢ denotes a security solution candidate, dⱼ 10 denotes an expected potential loss that may be caused by a threat j, and rᵢⱼ denotes a bypass rate matrix of the security solution candidate sᵢ with respect to the threat j.

To standardize the constraint, at least one of a total cost, a total residual risk and a total return on investment (ROI) of the security solution candidates, dependency/exclusiveness between the security solution candidates, and coerciveness of the security solution candidates may be standardized on the basis of IP.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings in which:

FIG. 1 is a flowchart showing a method of determining a security solution according to an exemplary embodiment of the present invention;

FIG. 2 illustrates an example of operation of an application performing a method of determining a security solution according to an exemplary embodiment of the present invention; and

FIG. 3 is a block diagram of an apparatus for determining a security solution according to an exemplary embodiment of the present invention.

### DETAILED DESCRIPTION OF EXEMPLARY EMBODIMENTS

The foregoing and other objects, features and advantages of the invention will be apparent from the following more particular description of exemplary embodiments of the invention, as illustrated in the accompanying drawings.

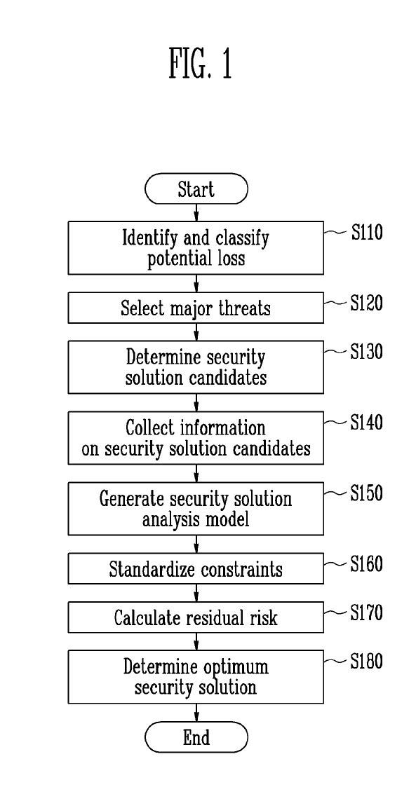

FIG. 1 is a flowchart showing a method of determining a security solution according to an exemplary embodiment of the present invention.

Referring to FIG. 1, the method of determining a security solution according to an exemplary embodiment of the present invention includes a step of identifying and classifying potential losses affecting a business goal (S110), a step of selecting major threats from among threats causing the potential losses (S120), a step of composing security solution combinations by determining security solution candidates for protecting information property from the major threats (S130), a step of collecting information on the security solution candidates (S140), a step of generating a security solution analysis model for analyzing effects on investment of the security solution combinations consisting of the security solution candidates on the basis of integer programming (IP) (S150), a step of standardizing constraints on the basis of IP (S160), a step of calculating a total residual risk of the security solution combinations by applying the standardized constraints to the security solution analysis model (S170), and a step of determining a security solution combination having the smallest residual risk as an optimum security solution combination (S180).

(1) Step of Identifying and Classifying Potential Losses (S110)

In this step, potential losses affecting a business goal are identified and classified according to type. Here, weights are given to the potential losses according to the degree of influence on the business goal.

(2) Step of Selecting Major Threats (S120)

In this step, major threats that have a strong effect on the potential losses are selected from among threats causing the potential losses and are given orders of priority. In this way, the range of threats is reduced to simplify an analysis process required for determining security solution candidates as much as possible.

(3) Step of Determining Security Solution Candidates (S130)

In this step, security solution candidates for protecting information property from the major threats are determined, and security solution combinations are composed of the determined security solution candidates.

Here, the security solution candidates may include security solutions such as a virtual private network (VPN), secure e-mail, a proxy firewall, a network monitoring tool, an electronic signature, an authorization policy server, an authentication token and an antivirus product.

When N security solution candidates are determined, a security solution combination S may be expressed in a vector form as S=(s₁, s₂, . . . , sᵢ) (i=1, 2, . . . , N). Here, sᵢ is a binary variable that indicates each security solution candidate and has a value of 0 or 1. sᵢ has the value of 0 when the corresponding security solution candidate is not selected, and the value of 1 when the corresponding security solution candidate is selected.

(4) Step of Collecting Information on Security Solution Candidates (S140)

In this step, information on costs, bypass rates, and expected potential losses of the respective security solution candidates is collected. Such information may be previously stored in a specific database.

(5) Step of Generating Security Solution Analysis Model (S150)

In this step, a security solution analysis model f for analyzing effects on investment of the security solution combination S on the basis of IP is generated. The security solution analysis model f is defined as shown in Equation 2 below.

$$f ( {s}_{1} , {s}_{2} , … , {s}_{N} ) = {\sum }_{j = 1}^{M} ( {d}_{j} \cdot {\prod }_{i = 1}^{N} ( ( {r}_{ij} - 1 ) \cdot {s}_{1} + 1 ) ) \qquad [ Equation 2 ]$$

In Equation 2, M denotes the number of threats, N denotes the number of security solution candidates, si denotes a security solution candidate, dⱼ denotes an expected potential loss that may be caused by a threat j, and rᵢⱼ denotes the bypass rate that is the protection ratio of the security solution candidate sᵢ evaluated between 0 and 1. The bypass rate rᵢⱼ of 0 means that the security solution candidate sᵢ can completely protect information property from the threat j, and the bypass rate rᵢⱼ of 1 means that the security solution candidate sᵢ is totally ineffective.

In other words, the security solution analysis model f calculates a total residual risk on the basis of IP according to the bypass rate matrix rᵢⱼ of the security solution candidates included in the security solution combination S and the currently-expected potential loss dⱼ.

As mentioned above, some of several security solution candidates to be implemented are very difficult to determine because the determination involves a variety of complex constraints, e.g., a cost, a return on investment (ROI), an acceptable risk level, and dependency between security solutions.

To solve this problem, the present invention standardizes several constraints on the basis of IP, which is a mathematical standardization technique, and applies the standardized constraints to the security solution analysis model f.

When several constraints are standardized and applied to the security solution analysis model f, the above-mentioned problem of complex determination becomes a problem of determining the security solution 20 combination S having the smallest residual risk while satisfying the constraints.

(6) Step of Standardizing Constraints (S160)

\textcircled{1} Total cost: The total cost of security solution candidates must be a limited investment budget or less.

$${\sum }_{i = 1}^{N} {s}_{i} {c}_{i} \leq {c}_{T}$$

Here, sᵢ denotes a security solution candidate, cᵢ denotes the cost of the security solution candidate sᵢ, and c_{T} denotes a limited investment budget.

\textcircled{2} Total residual risk: A total residual risk z of security solution candidates must be an acceptable value zₗᵢₘᵢₜ or less.

z≦zₗᵢₘᵢₜ

\textcircled{3} Total ROI: The total ROI of security solution candidates must be more than 0. In other words, selected security solution candidates must have a greater effect, i.e., benefit, than their cost.

$${\sum }_{i = 1}^{N} {s}_{i} ( {b}_{i} - {c}_{i} ) > 0$$

Here, sᵢ denotes a security solution candidate, bᵢ denotes returns of the security solution candidate sᵢ, and cᵢ denotes a cost of the security solution candidate sᵢ.

\textcircled{4} Dependency between security solution candidates: Security solution candidates sᵢ and sⱼ in a mutually dependent relationship are to be selected together.

sᵢ=sⱼ

\textcircled{5} Exclusiveness between security solution candidates: Security solution candidates sₓ and s_{y} in a mutually exclusive relationship are not to be selected together.

sₓ+sⱼ≦1

\textcircled{6} Coerciveness of security solution candidates: A security solution candidate sᵢ must be selected when the security solution candidate sᵢ has to be implemented due to a legal reason, etc., or has been already implemented.

sᵢ=1.

Besides the above-described constraints, additional constraints that a company must consider to make a determination can also be standardized.

(7) Step of Calculating a Total Residual Risk of Security Solution Combinations (S170)

In this step, the total residual risk of the security solution combination S is calculated by applying the standardized constraints to the security solution analysis model f.

The number of security solution combinations that can be composed of N security solution candidates is 2^{N}. However, when constraints are standardized as described above and applied to the security solution analysis model f, a feasible solution region can be drastically reduced by a branch-and-bound algorithm. Thus, it is possible to remarkably reduce the amount of computation.

(8) Step of Determining Optimum Security Solution (S180)

In this step, the security solution combination S=(s₁, S₂, . . . , s_{N}) having the smallest residual risk is determined as an optimum security solution combination.

When the constraints applied to the security solution analysis model f are changed, the optimum security solution combination may be changed. Therefore, the optimum security solution combination may be determined again according to the changed constraints.

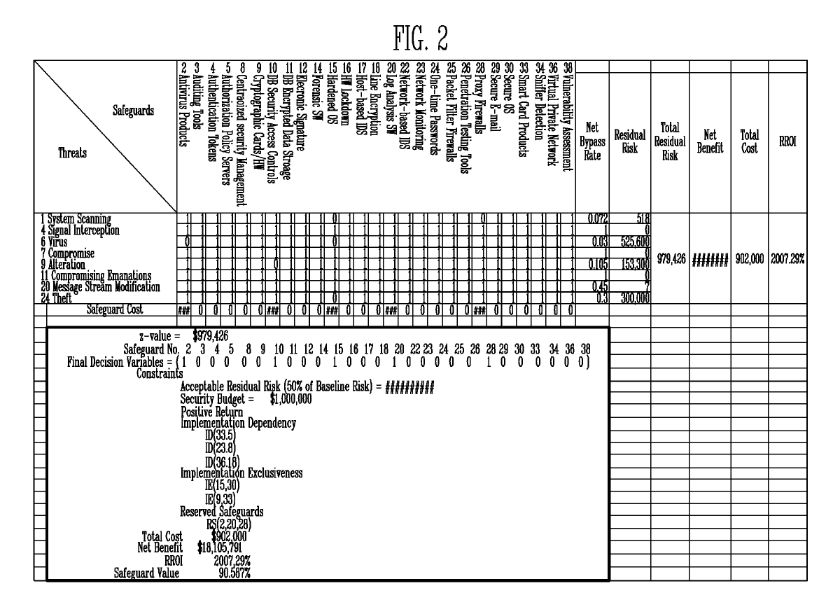

FIG. 2 illustrates an example of operation of an application performing a method of determining a security solution according to an exemplary embodiment of the present invention.

Referring to FIG. 2, residual risks of respective security solution combinations are automatically calculated using a security solution analysis model and output to support determination of a security solution.

Therefore, a security solution combination “100000000100010 00001000000” in which security solution candidates of antivirus product, database (DB) security access control, hardened operating system (OS), network-based intrusion detection system (IDS) and proxy firewall are selected is determined as an optimum security solution combination. In addition, the net benefit, total cost and risk-based ROI (RROI) of the determined optimum security solution combination are automatically calculated and output.

Here, all the information on the respective security solution combinations may be systematically arranged using a spreadsheet.

As described above, an exemplary embodiment of the present invention generates a security solution analysis model for analyzing effects on investment of security solution combinations consisting of security solution candidates, standardizes various constraints that have significant effects on security solution determination on the basis of IP, and applies the standardized constraints to the security solution analysis model, thereby determining a security solution combination having the smallest residual risk while satisfying the constraints as an optimum security solution combination.

Therefore, in comparison with a conventional security solution determination method in which comparison and evaluation are difficult due to a variety of complex constraints and a large number of security solution combinations, an exemplary embodiment of the present invention can rapidly and accurately determine an optimum security solution combination that can minimize a residual risk while satisfying various constraints. As a result, it is possible to support effective determination in information security investment.

In addition, since all the information on respective security solution combinations required for the determination is automatically provided to a determiner, he/she can easily determine an optimum security solution without much professional knowledge.

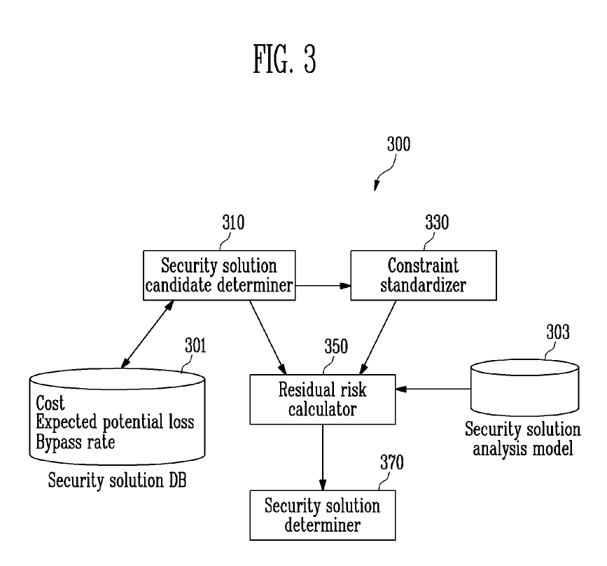

FIG. 3 is a block diagram of an apparatus for determining a security solution according to an exemplary embodiment of the present invention.

Referring to FIG. 3, an apparatus 300 for determining a security solution according to an exemplary embodiment of the present invention includes a security solution DB 301, a security solution analysis model 303, a security solution candidate determiner 310, a constraint standardizer 330, a residual risk calculator 350 and a security solution determiner 370.

For convenience, it is assumed that information on security solutions is stored in the security solution DB 301, and the security solution analysis model 303 for analyzing an effect on investment of a security solution combination on the basis of IP has been already implemented.

The security solution candidate determiner 310 determines security solution candidates from among available security solutions, thereby composing a security solution combination. The security solution candidates are determined as described in detail below.

First, the security solution candidate determiner 310 identifies potential losses affecting a business goal. Subsequently, major threats are selected from among threats causing the potential losses, and security solution candidates for protecting information property from the major threats are determined. Then, the security solution DB 301 collects information on the security solution candidates and transfers the collected information to the residual risk calculator 350. In the security solution DB 301, information on the costs, bypass rates, and expected potential losses of the security solution candidates is stored.

The constraint standardizer 330 standardizes several constraints on the basis of IP. The constraints may include the total cost, total residual risk and total ROI of the security solution candidates, dependency/exclusiveness between the security solution candidates, the coerciveness of the security solution candidates, and so on.

The residual risk calculator 350 calculates residual risks of the respective security solution combinations by applying the constraints standardized by the constraint standardizer 330 to the security solution analysis model 303.

Here, descriptions of the method of standardizing constraints and the method of calculating residual risks using the security solution analysis model are provided in detail with reference to FIG. 1, and thus will not be reiterated.

When the residual risks of the respective security solution combinations are calculated by the residual risk calculator 350, the security solution determiner 370 determines a security solution combination having the smallest residual risk as an optimum security solution combination.

In brief, when the constraint standardizer 330 in the security solution determination apparatus 300 according to an exemplary embodiment of the present invention standardizes various constraints affecting security solution determination, the residual risk calculator 350 calculates the residual risks of respective security solution combinations satisfying the standardized constraints using the security solution analysis model 303, and the security solution determiner 370 determines a security solution combination having the smallest residual risk as an optimum security solution combination.

Therefore, according to an exemplary embodiment of the present invention, it is possible to rapidly and accurately determine some security solutions to be implemented from among available security solutions in information security investment.

According to the present invention, an optimum security solution combination of available security solutions that can minimize a residual risk while satisfying several constraints can be rapidly and accurately obtained. Thus, it is possible to support effective determination in information security investment.

In addition, since all the information on respective security solution combinations required for the determination is automatically provided to a determiner, he/she can easily determine an optimum security solution without much professional knowledge.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of determining a security solution, comprising:
composing security solution combinations by determining security solution candidates from among available security solutions;
generating a security solution analysis model for analyzing effects on investment of the security solution combinations on the basis of integer programming (IP);
standardizing a constraint on the basis of IP;
calculating a total residual risk of the security solution combinations by applying the standardized constraint to the security solution analysis model; and
determining a security solution combination having a smallest residual risk as an optimum security solution combination.

2. The method of claim 1, wherein the composing of security solution combinations comprises:
identifying and classifying potential losses affecting a business goal;
selecting major threats from among threats causing the potential losses;
determining the security solution candidates for protecting information property from the major threats; and
composing the security solution combinations of the security solution candidates in a vector form expressed as S=(s₁, s₂, . . . , sᵢ),
wherein sᵢ denotes a binary variable indicating each security solution candidate and has a value of 0 or 1.

3. The method of claim 1, wherein, in generating the security solution analysis model, the security solution analysis model f is defined as
$$f ( {s}_{1} , {s}_{2} , … , {s}_{N} ) = {\sum }_{j = 1}^{M} ( {d}_{j} \cdot {\prod }_{i = 1}^{N} ( ( {r}_{ij} - 1 ) \cdot {s}_{i} + 1 ) ) ,$$
wherein M denotes the number of threats, N denotes the number of security solution candidates, sᵢ denotes a security solution candidate, dⱼ denotes an expected potential loss that may be caused by a threat j, and rᵢⱼ denotes a bypass rate matrix of the security solution candidate sᵢ with respect to the threat j.

4. The method of claim 1, wherein the standardizing of the constraint comprises standardizing at least one constraint among a total cost, a total residual risk and a total return on investment (ROI) of the security solution candidates, dependency/exclusiveness between the security solution candidates, and coerciveness of the security solution candidates, on the basis of IP.

5. The method of claim 4, wherein the standardizing of the constraint further comprises standardizing the total cost of the security solution candidates to be a limited investment budget or less as
$${\sum }_{i = 1}^{N} {s}_{i} {c}_{i} \leq {c}_{T} ,$$
wherein sᵢ denotes a security solution candidate, cᵢ denotes a cost of the security solution candidate sᵢ, and c_{T} denotes the limited investment budget.

6. The method of claim 4, wherein the standardizing of the constraint further comprises standardizing the total residual risk z of the security solution candidates to be an acceptable total residual risk zₗᵢₘᵢₜ or less as z≦zₗᵢₘᵢₜ.

7. The method of claim 4, wherein the standardizing of the constraint further comprises standardizing the total ROI of the security solution candidates to be more than 0 as
$${\sum }_{i = 1}^{N} {s}_{i} ( {b}_{i} - {c}_{i} ) > 0 ,$$
wherein sᵢ denotes a security solution candidate, bᵢ denotes returns of the security solution candidate sᵢ, and cᵢ denotes a cost of the security solution candidate sᵢ.

8. The method of claim 4, wherein the standardizing of the constraint further comprises, when security solution candidates sᵢ and sⱼ are in a mutually dependent relationship, standardizing the security solution candidates sᵢ and sⱼ as sᵢ=sⱼ to be selected together.

9. The method of claim 4, wherein the standardizing of the constraint further comprises, when security solution candidates sₓ and s_{y} are in a mutually exclusive relationship, standardizing the security solution candidates sₓ and s_{y} as sₓ+s_{y}≦1 not to be selected together.

10. The method of claim 4, wherein the standardizing of the constraint further comprises, when a security solution candidate sᵢ among the security solution candidates must be implemented or has been already implemented, standardizing the security solution candidate sᵢ as sᵢ=1.

11. The method of claim 1, wherein the composing of security solution combinations comprises collecting information on costs, bypass rates and expected potential losses of the respective security solution candidates.

12. An apparatus for determining a security solution, comprising:
a security solution candidate determiner for composing security solution combinations by determining security solution candidates from among available security solutions;
a security solution analysis model for analyzing effects on investment of the security solution combinations on the basis of integer programming (IP);
a constraint standardizer for standardizing a constraint on the basis of IP;
a residual risk calculator for calculating a total residual risk of the security solution combinations by applying the constraint standardized by the constraint standardizer to the security solution analysis model; and
a security solution determiner for determining a security solution combination having a smallest residual risk as an optimum security solution combination.

13. The apparatus of claim 12, wherein the security solution candidate determiner identifies potential losses affecting a business goal, selects major threats from among threats causing the potential losses, determines the security solution candidates for protecting information property from the major threats, and composes the security solution combinations of the security solution candidates in a vector form expressed as S=(s₁, s₂, . . . , sᵢ),
wherein sᵢ denotes a binary variable indicating each security solution candidate and has a value of 0 or 1.

14. The apparatus of claim 12, wherein the security solution candidate determiner collects information on costs, bypass rates and expected potential losses of the respective security solution candidates and transfers the collected information to the residual risk calculator.

15. The apparatus of claim 12, wherein the security solution analysis model f is defined as
$$f ( {s}_{1} , {s}_{2} , … , {s}_{N} ) = {\sum }_{j = 1}^{M} ( {d}_{j} \cdot {\prod }_{i = 1}^{N} ( ( {r}_{ij} - 1 ) \cdot {s}_{i} + 1 ) ) ,$$
wherein M denotes the number of threats, N denotes the number of security solution candidates, sᵢ denotes a security solution candidate, dⱼ denotes an expected potential loss that may be caused by a threat j, and rᵢⱼ denotes a bypass rate matrix of the security solution candidate sᵢ with respect to the threat j.

16. The apparatus of claim 12, wherein the constraint standardizer standardizes at least one constraint among a total cost, a total residual risk and a total return on investment (ROI) of the security solution candidates, dependency/exclusiveness between the security solution candidates, and coerciveness of the security solution candidates, on the basis of IP.

17. The apparatus of claim 16, wherein the constraint standardizer standardizes the total cost of the security solution candidates to be a limited investment budget or less as
$${\sum }_{i = 1}^{N} {s}_{i} {c}_{i} \leq {c}_{T} ,$$
wherein sᵢ denotes a security solution candidate, cᵢ denotes a cost of the security solution candidate sᵢ, and c_{T} denotes the limited investment budget.

18. The apparatus of claim 16, wherein the constraint standardizer standardizes the total residual risk z of the security solution candidates to be an acceptable total residual risk zₗᵢₘᵢₜ or less as z≦zₗᵢₘᵢₜ.

19. The apparatus of claim 16, wherein the constraint standardizer standardizes the total ROI of the security solution candidates to be more than 0 as
$${\sum }_{i = 1}^{N} {s}_{i} ( {b}_{i} - {c}_{i} ) > 0 ,$$
wherein sᵢ denotes a security solution candidate, bᵢ denotes returns of the security solution candidate sᵢ, and cᵢ denotes a cost of the security solution candidate sᵢ.

20. The apparatus of claim 16, wherein when security solution candidates sᵢ and sⱼ are in a mutually dependent relationship, the constraint standardizer standardizes the security solution candidates sᵢ and sⱼ as sᵢ=sⱼ to be selected together,
when security solution candidates sₓ and s_{y} are in a mutually exclusive relationship, the constraint standardizer standardizes the security solution candidates sₓ and s_{y} as sₓ+s_{y}≦1 not to be selected together,
and when a security solution candidate sᵢ among the security solution candidates must be implemented or has been already implemented, the constraint standardizer standardizes the security solution candidate sᵢ as sᵢ=1.
